(19) United States
(12) Patent Application Publication
(10) Pub. No.: US 2003/0208287 A1
(43) Pub. Date: Nov. 6, 2003

(54) Method and device for calculating process variables of an industrial process

(76) Inventors: Matthias Kurz, Erlangen (DE); Johannes Reinschke, Erlangen (DE)

Correspondence Address: BAKER BOTTS, LLP, 910 LOUISIANA, HOUSTON, TX, 77002-4995, US

(21) Appl. No.: 10/449,625

(22) Filed: May 30, 2003

Related U.S. Application Data
(63) Continuation of application No. PCT/DE01/04467, filed on Nov. 28, 2001.

(30) Foreign Application Priority Data
Nov. 30, 2000 (DE) 10059567.7

(51) Int. Cl. G05B 13/02

(52) U.S. Cl. 700/31

(57) ABSTRACT

A method and a device are provided for calculating in advance the process variables of an industrial process. The method, which consists of at least one empirical model and a core model, is subsequently adapted and optimized using a model that has a partial inverse structure in relation to the core model. The empirical models are optimized by means of adaption or training algorithms, which, in addition to known process parameters, have the empirical variables calculated by the partial inverse core model as basic input variables.

### CROSS-REFERENCE TO RELATED APPLICATION

This application is a continuation of co-pending International Application No. PCT/DE01/04467 filed Nov. 28, 2001 which designates the United States, and claims priority to German application number DE10059567.7 filed Nov. 30, 2000.

### FIELD OF THE INVENTION

The invention relates to a process and a device for calculating process variables.

### BACKGROUND OF THE INVENTION

In the closed-loop or open-loop control of industrial processes, in particular in the case of installations of the basic materials industry, such as for example steelworks, it is necessary to determine process variables or states in advance, since they are not available at the time at which they are needed in the closed-loop or open-loop control. Furthermore, it is desirable to optimize the calculation of these process variables or states online, i.e. during the production sequence.

It is common practice to determine process variables with the aid of a model. Before the beginning of each process sequence, known process parameters are used as a basis for calculating in advance required unknown process variables, with which a presetting of the system is performed. During the process sequence, the models used are optimized by means of measured process variables.

Adaptive models which are used in the process automation of industrial processes often comprise a physical core model. This core model describes the interrelationships which can be described in mathematical-physical terms with sufficient accuracy with the current state of knowledge (DE 43 38 608 A1). Process variables for which no sufficiently accurate mathematical-physical theory exists as yet are today determined by means of empirical models. These empirical models are either set up manually, i.e. during the commissioning of an industrial process installation, or adapted from direct comparison between measured process variables and calculated process variables.

### SUMMARY OF THE INVENTION

The object of the invention is to provide a method and device which make it possible to carry out a quick and efficient adaptation of empirical models.

The object is achieved according to the invention by a method with the following features: determining process parameters, also referred to as empirical variables, from known process parameters in at least one empirical model and determining process variables in a manner dependent on the known process parameters and the empirical variables in a core model, wherein the empirical model is adapted by means of a core model partially inverse with respect to the core model.

The method according to one embodiment of the invention comprises a core model and one or more empirical models, the empirical models being adapted by a so-called “partial inverse core model”. In the empirical model, process variables for which no adequately accurate mathematical-physical theory is known as yet are calculated. By contrast with the empirical models, in the physical core model only process variables for which the mathematical-physical dependencies are known with sufficient accuracy on the basis of the current state of knowledge are calculated. The input variables of the empirical models, the output variables of which are to be referred to as empirical variables, are known process parameters. The empirical variables and known process parameters are entered into the core model as input variables. In the case of the output variables of the core model, a distinction is made between measurable process variables and other process variables. The model constructed as partially inverse to the core model (referred to as “partial inverse core model” for short) has as input variables a suitable selection of measurable process variables and also all the known parameters entered into the core model. The output variables of the partial inverse core model are the empirical variables already mentioned above.

According to an advantageous refinement of the method, the core model and the inverse core model are compatible with each other, apart from numerical rounding errors, and both models are capable of being operated online in respect of computing time. For each measured set of data of measurable process variables, the partial inverse core model can be used to determine exactly (to within the measuring accuracy of the selected measurable process variables) which values the empirical variables should have had at the measuring time in order for the model predictions of the core model to coincide as well as possible with the selected measured values. With this knowledge of the empirical variables at the measuring time, the empirical models can be adapted.

A further advantageous refinement of the invention is that adaptation of the process variables in the sense of reducing the determined deviation is performed by means of adaptation or training algorithms, such as for example with a gradient descent method.

The device according to another embodiment of the invention comprises a computing system of an industrial process for calculating unknown process parameters, also referred to as empirical variables, in a manner dependent on known process parameters in at least one empirical model, and for calculating process variables in a manner dependent on the known process parameters and the empirical variables in a core model, the empirical model being adapted by means of a core model which is partially inverse with respect to the core model.

### BRIEF DESCRIPTION OF THE DRAWINGS

The invention and further advantages and details are explained in more detail below on the basis of a schematically represented exemplary embodiment in the drawing:

FIG. 1 shows an example of the configuration according to the invention of an empirical model, a core model and a partial inverse core model.

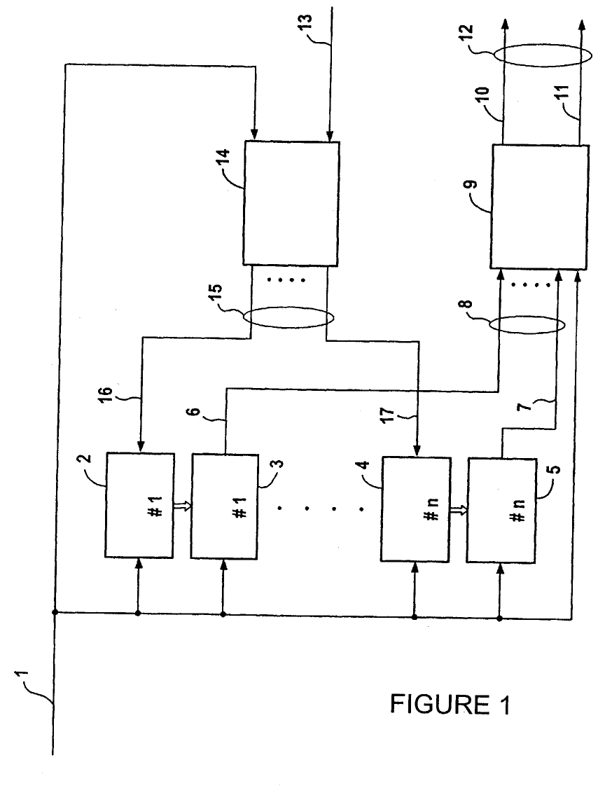

### DETAILED DESCRIPTION OF THE PREFERRED EMBODIMENTS

The exemplary embodiment shows the method according to the invention for calculating process variables 12 of an industrial process. The process model represented is used for example for calculating the rolling forces, the rolling moments, the rolling capacity and the forward slip for all the rolling stands of a five-stand cold rolling train (tandem train). One empirical model 3, 5 in each case models the unknown process parameters 6, 7. Unknown process parameters 6, 7 in a five-stand tandem train are the friction values between the rolled strip and the live rolls of each rolling stand, i.e. there are five empirical friction value models. Furthermore, there is an empirical model 3, 5 for the flow stress curve, which is assumed to be represented by a piecewise linear function with 5 interpolation points. Consequently, in the exemplary embodiment represented there are altogether six empirical models 3, 5 (symbolically represented by #1 . . . #n). For modeling the unknown process parameters 6, 7, also known as empirical variables, neural networks are used for example. Input variables of these empirical models are known process parameters 1. The sum of all the empirical variables 8 and also the known process parameters 1 serve as input variable for the core model, in which the process variables 12, such as for example the rolling forces, rolling moments, rolling capacities and forward slips of all five rolling stands are calculated. In the case of the calculated process variables 12, a distinction is made between (selected) measurable process variables 10 and other process variables 11. To be understood as selected measurable process variables 10 are the rolling forces and the forward slip of each rolling stand. The rolling moments and the rolling capacities belong to the other process variables 11. To be understood as an example of known process parameters are the strip thickness ahead of the first stand, the draft per stand, the strip tensions ahead of the first stand and the last stand and the strip tensions between the stands, the radii of the live rolls, the strip speed after the last stand, etc. There are also known process parameters 1, such as the chemical composition of the rolled stock, the input variables of an empirical model 3, 5 (that is of the flow stress model), but not of the core model 9. Serving as input variables for the partial inverse core model 14 are those known process parameters 1 which are also input variables of the core model 9 and also the measured process variables 13. The output variables 15 of the inverse core model are the empirical variables already mentioned above, which however are calculated in a manner dependent on the measured process variables 13. What is important is that the core model 9 and the partial inverse core model 14 are compatible with each other, apart from numerical rounding errors, and both models are capable of being operated online in respect of computing time. For each measured set of measurable process variables 13, the partial inverse core model 14 can be used to determine exactly which values the empirical variables 15 should have had at the measuring time in order for the (selected) measurable process variables 10 calculated by the core model to coincide as well as possible with the actually measured process variables 13. With the calculated empirical variables 15, the empirical models 3, 5 can be adapted or optimized. The adaptation or optimization of the empirical models 3, 5 is performed by means of adaptation or training algorithms 2, 4. The adaptation or training algorithms 2, 4 have the calculated empirical variables 16, 17 and also the known process parameters 1 as input variables. The adaptation and training algorithms 2, 4 belonging to the empirical models 3, 5 realized in the form of neural networks are based on a gradient descent method, i.e., depending on the deviation, an adaptive change of the model parameters contained in the neural networks is performed in the sense of a reduction of the determined deviation. The model parameters adapted in this way are available for the calculation of the empirical variables 6, 7 at the beginning of the next process sequence.

What we claim is:

1. A method for calculating process variables of an industrial process, in particular of an installation of the basic materials industry, said process comprising:
determining process parameters, also referred to as empirical variables, from known process parameters in at least one empirical model; and
determining process variables in a manner dependent on the known process parameters and the empirical variables in a core model, wherein the empirical model is adapted by means of a core model partially inverse with respect to said core model.

2. The method as claimed in claim 1, wherein the partial inverse core model is compatible with the core model.

3. The method as claimed in claim 2, wherein the partial inverse core model is determined in a manner dependent on known process parameters and on measured process variables, the empirical variables, existing at the measuring time.

4. The method as claimed in claim 3, wherein an adaptation or training algorithm is used to adapt at least one empirical model by means of the empirical variables existing at the measuring time, calculated by the partial inverse core model.

5. A method for calculating process variables of an industrial process, said method comprising:
calculating unknown process parameters via a computing system in a manner dependent on known process parameters in at least one empirical model;
determining process variables in a manner dependent on the known process parameters and the empirical variables and a core model, wherein the empirical model is adapted by means of a core model which is partially inverse with respect to said core model.

6. A method for calculating process variables of an industrial process, said method comprising: determining empirical values from known process parameters in at least one empirical model, and determining process variables in a manner dependent on the known process parameters and the empirical variables in a core model, the empirical model adapted by means of a partially inverse core model.

7. The method as claimed in claim 6, wherein the partially inverse core model is compatible with the core model.

8. The method as claimed in claim 7, wherein the partially inverse core model determines the empirical variables existing at the measuring time in a manner dependent on known process parameters and on measured process variables.

9. The method as claimed in claim 8, wherein an adaptation or training algorithm is used to adapt at least one empirical model by means of the empirical variables existing at the measuring time, calculated by the partially inverse core model.
